(19) United States
(12) Patent Application Publication
(10) Pub. No.: US 2005/0152936 A1
(43) Pub. Date: Jul. 14, 2005

(54) Eradication system for nesting insects

(76) Inventor: Tommy Taylor, Lake Charles, LA (US)

Correspondence Address: Henry E. Naylor & Associates, LLC, P.O. Box 86060, Baton Rouge, LA, 70879-6060, US

(21) Appl. No.: 11/013,780

(22) Filed: Dec. 16, 2004

Related U.S. Application Data
(63) Continuation-in-part of application No. 10/796,498, filed on Mar. 9, 2004.
Application No. 10/796,498 is a continuation-in-part of application No. 09/969,329, filed on Oct. 2, 2001, now Pat. No. 6,831,104.

(51) Int. Cl. A01N 43/54; A01N 25/00; A01N 29/00

(52) U.S. Cl. 424/405; 514/743

(57) ABSTRACT

A system for eradicating nesting insects, which system is comprised of one or more halocarbons possessing insecticidal knockout activity and at least one insecticide. The present invention also relates a method for eradicating nesting insects by applying a mixture of one or more halocarbons possessing insecticidal knockout activity and at least one insecticide to the insect nest.

### CROSS-REFERENCE TO RELATED APPLICATIONS

This application is a continuation-in-part of U.S. Ser. No. 10/796,498 filed Mar. 9, 2004 which is a continuation-in-part of U.S. Ser. No. 09/969,329 filed Oct. 2, 2001 now U.S. Pat. No. 6,831,104.

### FIELD OF THE INVENTION

The present invention relates to a system for eradicating nesting insects, which system is comprised of one or more halocarbons possessing insecticidal knockout activity and at least one insecticide. The present invention also relates a method for eradicating nesting insects by applying a mixture of one or more halocarbons possessing insecticidal knockout activity and at least one insecticide to the insect nest.

### BACKGROUND OF THE INVENTION

Insect pest infestations, particularly nesting insect infestations, present a significant problem to homeowners, landowners, livestock, vegetation, machinery and electrical equipment. In the United States, Red Imported Fire Ants (RIFA) are a particularly problematic invasive species. RIFA have spread from the Gulf Coast to both the East and West Coasts within, the past eighty years.

RIFA live in colonies comprised of thousands of individuals. When their dirt mounds are disturbed, the ants swarm upon the invader delivering relentless and extremely painful stings. In humans, the stings cause itching welts that may last for many days. Scratching the wounds may lead to infection and some persons may even suffer severe allergic reactions. Small children unfamiliar with the habits of the fire ant are particularly susceptible to attack. Fire ants pose an even greater danger to livestock. Fire ant mounds frequently dot pastures in the Southern United States and cattle may suffer from swarming attacks. Abundant fire ant stings can kill calves and other small animals. Ground dwelling animals are particularly susceptible to fire ant predation. Some species such as the Southern gopher tortoise, the bob-white quail and the Atwater prairie chicken face endangerment or extinction due in large part to fire ant predation. Vegetation is also susceptible to depletion by foraging fire ants. Furthermore, fire ants that have infested agricultural fields pose a threat to humans harvesting crops.

A common method currently in use for controlling fire ants involves the application of granules coated with a water-soluble poison directly onto a fire ant mound, and then gently dousing the mound with water, so that the poisonous coating is dissolved and carried into the colony. One brand of such product, Spectracide.RTM., which is comprised of Diazinon.RTM. (C₁₂H₂₁N₂O₃PS), advertises that it will kill fire ants within 24 hours. Unfortunately, the technique is somewhat ineffective. Individual insects may be observed moving actively about the targeted colony when the insecticide granules and/or water are applied. Furthermore, new fire ant colonies, presumably individuals and an unharmed queen from the targeted colony, have been observed to form in the immediate vicinity of the original mound within 12 hours of the treatment.

Another common technique currently employed for controlling the fire ant problem involves the use of “baiting” systems, wherein a poison is implanted into a fire ant food source, which is carried back into the fire ant colony by worker ants. This technique, while considered environmentally advantageous, has the distinct disadvantage of being relatively slow acting when compared to direct application of insecticide to the fire ant colony. For example, one of the faster-acting “baits” is Amdro.RTM., which is comprised of hydramethylnon and has the chemical name tetrahydro-5,5-dimethyl-2(1H)-pyrimidinone {3-{4-(trifluoromethyl)phenyl}-1-{2-{4-trifluoromethyl)phenyl}ethenyl}-2-propenyl-idene}hydrazone. When it is broadcast it is reported to have a maximum 80%-90% effectiveness rating in 3 to 8 weeks. In such time, it is highly probable that the rapidly propagating fire ant would establish new colonies not far from baited sites. Furthermore, a “baiting” system is always subject to the foraging whimsy of the individual fire ant. When other food sources are accessible fire ants may not even seize the bait. In addition, these baits are always subject to dilution and/or dispersion by rains and flooding, potentially rendering them ineffective in targeted areas.

While there are many commercially available insecticide systems for killing insects, particularly those that colonize or nest in great numbers, there remains a continuing need in the art for systems that are more effective for killing substantially all insects in a colony.

### SUMMARY OF THE INVENTION

In accordance with the present invention there is provided a system for the eradication of nesting insects, which system comprising at least one insecticide and a knockout agent comprised of at least one halocarbon compound and, wherein the halocarbon compound is selected from those represented by the following formulae:
CₐH_{b}F_{c}Cl_{d}Brₑ i)
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers;
   CₐH_{b}F_{c}Cl_{d}BrₑO ii)
   wherein:
a is from 2 to 5,
b is from 0 to 11
c is from 0 to 11,
d is from 0 to 3, and
e is from 0 to 2,
with the provision that: i) at least one of F, Cl or Br must be present; ii) that when only F is present there must be at least 5 Fs; and iii) that all ranges are in whole numbers; and
   CₐH_{d}F_{c}Cl_{d}Brₑ(OH) iii)
   wherein:
a is from 1 to 5,
b is from 0 to 11,
c is from 0 to 11,
d is from 0 to 3, and
e is from 0 to 2,
with the proviso that: i) at least one of F, Cl, or Br must be present; ii) that when only F is present there must be at least 5 Fs; and iii) that all ranges are in whole numbers.

In a preferred embodiment, the halocarbon compound is selected from
CₐH_{b}F_{c}Cl_{d}Brₑ
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers.

In another preferred embodiment, the halogen of the halocarbon compound is selected from Cl and Br.

In a preferred embodiment, the halocarbon compound is selected from the group consisting of 1,1-dichloro-1-fluoroethane (HCFC-141b); 3,3-dichloro-1,1,1,2,2-pentafluoropropane (HCFC-225ca); and 1,3-dichloro-1,1,2,2,3-pentafluropropane (HCFC-225cb); and a mixture of 3,3-dichloro-1,1,1,2,2-pentafluoropropane (HCFC-225ca); and 1,3-dichloro-1,1,2,2,3-pentafluropropane (HCFC-225cb), which mixture is typically referred to as HCFC 225.

Also in accordance with the present invention there is provided a method for eradicating nesting insects, which method comprises, applying to the nest of insects a mixture comprised of an effective amount of at least one of the above referenced halocarbon compounds and at least one insecticide.

In still another preferred embodiment only one or more knockout agents are applied to the nest of insects, more preferably a dichloroethylene with one or more other knockout agents.

In another preferred embodiment the halocarbon is blended with other active ingredients, inerts or adjuvants and applied to an insect infestation.

### DETAILED DESCRIPTION OF THE INVENTION

The term “halocarbon compound”, as used herein, includes compounds containing only carbon, hydrogen, and halogen atoms as well as those that also contain an oxygen atom to form an ether and also those that also contain an —OH group to form an alcohol. Preferred are halocarbon compounds that only contain carbon, hydrogen and halogen atoms wherein the halogen is selected from the group consisting of Cl, F, and Br.

Non-limiting examples of halocarbon compounds that can be used in the practice of the present invention are those that are represented by the following three formulae:
CₐH_{b}F_{c}Cl_{d}Brₑ (i)
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers;
   CₐH_{b}F_{c}Cl_{d}BrₑO ii)
   wherein:
a is from 2 to 5,
b is from 0 to 11
c is from 0 to 11,
d is from 0 to 3, and
e is from 0 to 2,
with the provision that: i) at least one of F, Cl or Br must be present; ii) that when only F is present there must be at least 5 Fs; and iii) that all ranges are in whole numbers; and
   CₐH_{b}Cl_{d}Brₑ(OH) iii)
   wherein:
a is from 1 to 5,
b is from 0 to 11,
c is from 0 to 11,
d is from 0 to 3, and
e is from 0 to 2,
with the proviso that: i) at least one of F, Cl, or Br must be present; ii) that when only F is present there must be at least 5 Fs; and iii) that all ranges are in whole numbers.

In a preferred embodiment, the halocarbon compound is selected from
CₐH_{b}F_{c}Cl_{d}Brₑ
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers.

In another preferred embodiment, the halogen of the halocarbon compound is selected from Cl and Br.

It is preferred that the halocarbon component, or compound used in the practice of the present invention have a boiling point less than about 80° C., more preferably less than about 60° C., and most preferably less than about 55° C. It is also preferred that the boiling point of the halocarbon compound be greater than about 15° C. Also preferred is that the halocarbon compound have a Kauri Butano Value greater than about 9, more preferably greater than about 40. The Kauri Butano value is measured by ASTM D1133-04 Standard Test Method for Kauri Butanol Value of Hydrocarbon Solvents.

Non-limiting examples of more preferred halocarbon compounds of the present invention are those selected from the group consisting of 1,1-dichloro-1-fluoroethane (HCFC-141b); 3,3-dichloro-1,1,1,2,2-pentafluoropropane (HCFC-225ca); and 1,3-dichloro-1,1,2,2,3-pentafluropropane (HCFC-225cb); and a mixture of 3,3-dichloro-1,1,1,2,2-pentafluoropropane (HCFC-225ca); and 1,3-dichloro-1,1,2,2,3-pentafluropropane (HCFC-225cb); which mixture is typically referred to as HCFC 225. Ideally, the less toxic HCFC-225cb isomer would be isolated and used in preference to a mixture of the two isomers, though it is currently unfeasible to separate the two isomers. Non-limiting examples also include 1,1,2,2,3-pentafluoropropane (HFC-245ca); 1,1,2,3,3-pentafluoropropane (HFC-245ea); 1,1,1,2,3-pentafluoropropane (HFC-245eb); and 1,1,1,3,3-pentafluoropropane (HFC-245fa). The most preferred halocarbon compound is 1,1-dichloro-1-fluoroethane.

It is also preferred that one or both of cis-dichloroethylene or trans-dichloroethylene be used as a mixture with 1,1-dichloro-1-fluoroethane, or as a mixture with 3,3-dichloro-1,1,1,2,2-pentafluoropropane; 1,3-dichloro-1,1,2,2,3-pentafluropropane, or with both. It is preferred that trans-dichloroethylene be used instead of cis-dichloroethylene. Also preferred is a mixture of cis-dichloroethylene or trans-dichloroethylene with one or more of 1,1,2,2,3-pentafluoropropane (HFC-245ca); 1,1,2,3,3-pentafluoropropane (HFC-245ea); 1,1,1,2,3-pentafluoropropane (HFC-245eb); and 1,1,1,3,3-pentafluoropropane (HFC-245fa), more preferably with 1,1,1,3,3-pentafluoropropane (HFC-245fa). It is also preferred that these mixtures be used in aerosol for to treat insect infestations contiguous to electrical equipment. That is, only the mixture of knockout agents be used to treat an insect infestation near electrical equipment.

The one or more halocarbon compounds will be used in an effective amount. That is at least that minimum amount of one or more halocarbons needed to knock out or otherwise render substantially all of the insects in the nest unconscious and unable to move, but not killed.

The one or more halocarbon compounds are used to knockout nesting insects such as the Red Imported Fire Ant. That is, it will render the nesting insects unconscious and unable to move for long enough periods of time that their entire nests can be moved without individual ants swarming or escaping. During this time of inactivity, the insects can be subjected to a suitable insecticide, thus killing substantially all insects in the nest or colony. Also during this time of inactivity, a worker can work in the vicinity of the nest without fear of attack from the insects. This is important when work needs to be performed with electrical equipment that is contiguous to a nest of insects, such as fire ants. Since water typically cannot be used around electrical equipment, the nest of insects can be rendered inactive by use of the one or more halocarbon compounds for a long enough period of time for the worker to complete his or her work. Thus, it is within the scope of this invention that a conventional insecticide not be used with the halocabon compound of the present invention, but the halocarbon compound be used alone to inactivate the insects, and in some cases kill a substantial number of them.

The present invention preferably relates to a multi-agent insecticide system for killing a substantial number of insects of an infestation. Non-limiting examples of nesting infestations include earthen mounds, nests, hives, colonies, swarms, and clusters. Conventional insecticide applications relate to the use of certain chlorinated hydrocarbons as carriers, or solvents, for insecticides, or as insecticides themselves. None of the conventional insecticides that are based on chlorinated hydrocarbons are substantially benign to the environment. Chlorinated hydrocarbons used in conventional insecticide applications are generally highly stable molecules that are not readily decomposed in the lower atmosphere. The inventor hereof has unexpectedly discovered that a substantial number, preferably substantially all, insects in an infestation are killed by use of a non-lethal knockout agent in combination with an insecticide. The term “knockout” or “non-lethal knockout” as used herein means that the insects are rendered unconscious and are unable to move but are still alive. It will be understood that the terms “incapacitated”, “immobilized”, “inert”, unconscious, and “unable to move” are used interchangeably herein. If an insecticide with rapid killing power is not used in combination with the knockout agent the insects will eventually return to a normal active state. The knockout agents of the present invention are capable of incapacitating the insects for up to 2 or more hours. This allows sufficient time to remove the entire nest of insects without danger of swarming or escape of the individuals. Alternatively, this allows sufficient time for a contact insecticide with rapid killing power to be applied to kill them. The use of the knockout agents of the present invention allows one to use more environmentally acceptable insecticides since the insecticides themselves do not instantly render the insects unable to move. To kill substantially all insects of a colony without the use of combination knockout agent/insecticide one would need to use very powerful environmentally unacceptable insecticides. Most of such insecticides have been removed from the consumer market.

Typically, once the insects have been in contact with the knockout agent, they will be unconscious and thus incapacitated for a finite period of time. If an insecticide is not applied, they will recover and resume their normal activity. Although the knockout agent is effective in a liquid as well as vapor form, it is preferred that the target insects be subjected to the vapor form. That is, although the knockout agent is applied in liquid form it quickly vaporizes upon application and permeates the nest. It has been found that substantially all of the insects of an infestation can be eradicated by first incapacitating them with a knockout agent, thus rendering them unable to move, then contacting them with a rapidly acting insecticide.

In tests conducted by the inventor hereof, both 1,1-dichloro-1-fluoroethane (HCFC-141b) or a mixture of 3,3-dichloro-1,1,1,2,2-pentafluoropropane (HCFC-225ca) and 1,3-dichloro-1,1,2,2,3-pentafluoropropane (HCFC-225cb) when applied superficially to a fire ant mound, proved effective in rendering substantially all individual insects in the targeted fire ant mound unable to move until a suitable poison could make contact with, and kill, all individual insects, most notably the fire ant queen.

A diluent can be used in combination with the knockout agent. The diluent can be an organic compound in which the knockout agent is at least partially soluble or miscible, preferably substantially entirely soluble or miscible. Non-limiting examples of diluents include: (1) oils, preferably biodegradable vegetable oils; (2) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (3) ketones or ketoalcohols such as acetone, methyl ethyl ketone and diacetone alcohol; (4) ethers, such as tetrahydrofuran and dioxane; (5) esters, such as ethyl acetate, ethyl lactate, ethylene carbonate and propylene carbonate; (6) polyhydric alcohols, such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol; (7) lower alkyl mono- or di-ethers derived from alkylene glycols, such as ethylene glycol mono-methyl (or -ethyl) ether, diethylene glycol mono-methyl (or -ethyl) ether, propylene glycol mono-methyl (or -ethyl) ether, triethylene glycol mono-methyl (or -ethyl) ether and diethylene glycol di-methyl (or -ethyl) ether; (8) nitrogen containing cyclic compounds, such as pyrrolidone, N-methyl-2-pyrrolidone, and 1,3-dimethyl-2-imidazoli- dinone; and (9) sulfur-containing compounds such as dimethyl sulfoxide and tetramethylene sulfone. Water can also be used as the diluent. More preferred are alcohols, biogradeable oils, and water. Most preferred are alcohols and water, particularly water.

Any insecticide that is lethal to the targeted insects can be used in the practice of the present invention. Non-limiting examples of such insecticides include the organochlorines (chlorinated hydrocarbons) which includes diphenyl aliphatics, hexchlorocyclohexane, cyclodienes, polychloroterpenes, and the like; the organophosphates inclusive of aliphatics such as malathion, phenyl derivatives such as the alkyl parathions, and heterocyclic derivatives such as Diazinon®; the organosulfurs such as tetradifon, propargite, and ovex; the carbamates that are derivatives of carbamic acid such as carbaryl; the dinitrophenols such as binapacryl and 2,4-dinitrophenol; the organotins such as cyhexatin; the pyrethroids such as permethrin, allethrin, tetramethrin, fenvalerate, cypermethrin, flucythrinate, fluvalinate, deltamethrin, and bifenthrin; the nicothinoids such as imidacloprid; the spinosyns such as spinosad which is a mixture of spinosyns A and D; the fiproles or phenylpyraxoles such as fipronil; the pyrroles such as chlorfenapyr; the pyrazoles such as tebufenpyrad; the phridazinones such as pyridaben; the quinazolines such as 4-[[4-(1,1-dimethylethyl)phenyl]et-hoxy]quinazoline; the benzoylureas such as triflumuron and diflubenzuron; the botanicals such as pyrethrum, nicotine, rotenone, and d-limonene; the synergists such as piperonyl butoxide; the antibiotics such as the avermectins and emamectin benzoate; the fumigants such as sulfuryl fluoride and the like; the inorganics such as inorganic fluorides like sodium fluoride; barium fluoride, and crylite; as well as miscellaneous compounds such as pyriproxyfen, buprofezin, clofentezine, sodium tetrathiobarbonate, hydramethylnon, and the like. A detailed description of such insecticides can be found in The Pesticide Book, by George W. Ware, 5.sup.th edition, 2000, Thomson Publications and incorporated herein by reference. More preferred insecticides include organophosphorous (particularly Diazinon®) and pyrethroids (particularly permethrin). It will be understood that any of these insecticides can be used that are effective for the targeted insects. It will also be understood that some of these insecticides are no longer commercially available because of their hazard to the environment, but are nevertheless effective from a technical point of view for eliminating insects. Further, some of these insecticides are only available to licensed professionals and not consumers.

One preferred insecticide class for use in the present invention are organophosphorous compounds including phosphates, phosphoronionates, and phosphorothionates. For example, a suitable, well-known organophosphorous compounds, useful as toxicants in the present invention includes acetylphosphoramidithiotic acid O,S-dimethyl ester, more commonly called “Acephate,” and commonly available under the “Ortho” and Orthene” brand names (see also U.S. Pat. Nos. 3,716,600 and 3,845,172, both assigned to Chevron).

Other examples of suitable organophosphorous compounds which have toxic effects toward fire ants, include, but are not limited to, phosphorothioic acid O,O-diethyl O-(3,5,6-trichloro-2-pyridinyl) ester, also known by “Chlorpyrifos”, and commercially available under the “Dursban”, “Lorsban”, and “Pyrinex” brand names (see also U.S. Pat. No. 3,244,586 assigned to Dow Chemical); phosphorothioic acid O,O-diethyl O→6-methyl-2-(1-methylethyl)-4-pyrimidinyl!ester, also known by “Dimpylate”, and commercially available under the “Basudin”, Diazinon”, “Diazol”, “Garden Tox”, “Sarolex”, and “Spectracide” brand names (see also U.S. Pat. No. 2,754,243 assigned to Geigy); phosphorothioic acid O,O-dimethyl O-(3-methyl-4-nitrophenyl) ester, also known by “Fenitrothion”, and commercially available under the “Accothion”, “Cyfen”, Cyten”, “Folithion”, “MEP”, “Metathion” and “Sumithion” brand names (see also Belgian Pat. No. 594,669 to Sumitomo as well as Belgian Pat. No. 596,091 to Bayer); phosphorothioic acid O,O-dimethyl O→3-methyl-4-(methylthio)phenyl!ester, also known by “Fenthion”, and commercially available under the “Baycid”, “Baytex”, “Entex”, “Lebaycid”, “Mercaptophos”, “Queletox”, “Spotton”, “Talodex” and “Tiguvon” brand names (see also German Patent No. 1,116,656 as well as U.S. Pat. No. 3,042,703, both assigned to Bayer; see also Japanese Pat. No. 15,130, which issued in 1964 to Sumitomo); 4-ethoxy-7-phenyl-3,5-dioxa-6-aza-4-ph-osphaoct-6-ene-8-nitrile 4-sulfide, also known by “Phoxim”, and commercially available under the “Baythion”, “Sebacil” and “Volaton” brand names (see also U.S. Pat. No. 3,591,662 assigned to Bayer); and the O,O-dimethyl analog of O→2-(diethylamino)-6-methyl-4-pyrimidinyl!phos-phorothioic acid O,O-diethyl ester, also known by “Pirimiphos-methyl”, and commercially available under the “Actellic”, “Blex”, and “Silo San” brand names. (See, e.g., entry numbers 25, 2167, 2968, 3910, 3927, 7251 and 7372, respectively, in “The Merck Index”, 10th ed., published in 1983 by Merck & Co., Inc.). Another preferred insecticide is hydramethylnon.

Conventional insect pest eradication techniques for treating a colony of insects are usually ineffective since individual insects can escape the targeted area before a rapidly lethal insecticide has made contact and killed substantially all individuals. Use of the knockout agents of the present invention has an advantage over conventional insect eradication techniques because substantially all individual insects in a colony are knocked-out by the quickly spreading vapors of the knockout agent.

The present invention can be practiced by any suitable technique. For example, the knockout agent can first be applied superficially to an insect nest or mound to immobilize the insects. The vapors of the knockout agent will rapidly permeate the insect nest or mound, instantly rendering the insects unable to move. Then, a suitable insecticide can be applied to kill the immobilized insects. The knockout agent can also be mixed with the insecticide, either before or at time of application and the combination used to treat the insects to be eradicated. If the knockout agent and insecticide are mixed it is also within the scope of this invention that an emulsifier can be used. When an emulsifier is used it can be used in a concentration from about 0.2 to 10 wt. %. Non-limiting examples of suitable emulsifiers include mono-, di- and tri-sorbitan esters; polyoxethylene sorbitan esters; ethoxylated nonionic emulsifiers; propoxylated nonionic emulsifiers and ethyoxylated/propoxylated nonionic emulsifiers.

It is also within the scope of this invention that the knockout agent and insecticide be delivered in aerosol or fogger form. This will allow one to eradicate flying insects, as well as those that reside indoors, such as in attics and basements. One or more conventional propellants can be used for the aerosol in a concentration from about 2 to 80 wt. %, based on the total weight of the ingredients. Amongst the propellants that can be used are non-flammable as well as flammable propellants. It is preferred that non-flammable propellants be used for indoor application. Preferred non-flammable propellants include 1,1,1,2-tetraflouroethane (HFC 134a) and compressed gases, such as carbon dioxide. When tetraflouroethane is used it can be used in amounts of about 33 wt. % and will render the knockout agent, such as trans-dichloroethylene, non-flammable. Preferred flammable propellants suitable for use herein are hydrocarbons. Non-limiting examples of preferred hydrocarbon propellants include acetylene, methane, ethane, ethylene, propane, propene, n-butane, butene, isobutane, isobutene, pentane, pentene, isopentane, and isopentene. Mixtures of these propellants may also be used. It is also within the scope of this invention to treat fingus infestations with use of conventional fungidicides. The aerosol form is particularly useful when treating a nest or mound in the vicinity of electrical equipment.

The following examples serve to exemplify a more general description set forth above and are for illustrative purposes only and are not intended to limit the scope of the present invention in any way.

### EXAMPLES

The experimental method used herein entailed preparing two different mixtures and applying each mixture to an active mound of red imported fire ants. The first mixture comprised two fluid ounces 1,1-dichloro-1-fluoroethane (HCFC-141b) (“the knockout agent”), two fluid ounces vegetable oil, one fluid ounce of Bug-B-Gon® insecticide, an over-the-counter garden insecticide containing the registered active ingredient esfenvalerate, and one gallon of water. This aqueous mixture was then applied to the surface of an active fire ant mound approximately 12 inches in surface diameter.

The second mixture comprised two fluid ounces of an isomeric mixture of 3,3-dichloro-1,1,1,2,2-pentafluoropropane (HCFC-225ca) and 1,3-dichloro-1,1,2,2,3-pentafluoropropane (HCFC-225cb) (“the knockout agent”), two fluid ounces vegetable oil, one fluid ounce of Bug-B-Gon® insecticide and one gallon of water. This aqueous mixture was then applied to the surface of an active fire ant mound approximately 12 inches in surface diameter.

Following each of these test applications, the targeted fire ant colonies were excavated in the form of plugs. These “plugs” of excavated earth that had comprised the fire ant colony measured about 12″×12″×12″. The plugs were dissected and the insects observed. Hundreds, if not thousands, of dead individual worker ants, dead ant larvae and eggs were detected. In the deepest portion of the plugs, at least one queen fire ant was found dead. Occasionally, dead winged fire ants could be found among the exterminated colony. These excavations showed that the insect eradication system of the present invention was effective for eradicating substantially the entire colony of fire ants. No new fire ant mounds could be found in or near the vicinity of the targeted colony even several days after treatment. This was because no individual fire ants, nor fire ant queens, were able to flee the targeted colonies and establish new colonies.

It is anticipated that similar techniques can be employed to control any number of insect pests, including termites, wasps, fleas or cockroaches. In a similar manner, targeted colonies of insects or targeted areas of infestation could be treated with a spray comprising either of the subject knock-out agents and a suitable insecticide possessing rapid killing power in effective quantities. It is further anticipated that a spray or liquid comprising either of these knock-out agents but not comprising any additional insecticides may be used to knock out colonies of RIFA nesting in electrical equipment housings, telephone and cable equipment housings, or other machinery in order that the nests may be safely removed without harm to the equipment or to the person removing the nests.

Finally, it is anticipate that the knockout agent can be used itself as a carrier for an insecticide, and that this mixture alone, or blended with other miscibles, could be applied to an area infested with insect pests. The HCFC-141b/insecticide or HCFC-225ca-HCFC-225cb/insecticide mixture will have a similar, synergistic “knockout and poison” effect on individual insects. The mixture can be applied in liquid form to insect pest colonies. The mixture should also be suitable in aerosol applications, for instance in spray cans or insect “bombs.” It can be especially effective for funigating homes infested with termites, fleas or cockroaches.

1. A system for the eradication of nesting insects, which system comprising a halocarbon component and at least one insecticide, wherein the halocarbon component is comprised of at least one halocompound selected from those represented by the following formulae:
CₐH_{b}F_{c}Cl_{d}Brₑ i)
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers;
CₐH_{b}F_{c}Cl_{d}BrₑO ii)
wherein:
a is from 2 to 5,
b is from 0 to 11
c is from 0 to 11,
d is from 0 to 3, and
e is from 0 to 2,
with the provision that: i) at least one of F, Cl or Br must be present; ii) that when only F is present there must be at least 5 Fs; and iii) that all ranges are in whole numbers; and
CₐH_{b}F_{c}Cl_{d}Brₑ(OH) iii)
wherein:
a is from 1 to 5,
b is from 0 to 11,
c is from 0 to 11,
d is from 0 to 3, and
e is from 0 to 2,
with the proviso that: i) at least one of F, Cl, or Br must be present; ii) that when only F is present there must be at least 5 Fs; and iii) that all ranges are in whole numbers.

2. The system of claim 1 wherein the halocarbon component has a boiling point less than about 80° C.

3. The system of claim 1 wherein halocarbon component has a Kauri Butano Value greater than about 9.

4. The system of claim 1 wherein the halocarbon component is selected from the group consisting of 1,1-dichloro-1-fluoroethane; 3,3-dichloro-1,1,1,2,2-pentafluoropropane; and 1,3-dichloro-1,1,2,2,3-pentafluropropane; 1,1,2,2,3-pentafluoropropane; 1,1,2,3,3-pentafluoropropane; 1,1,1,2,3-pentafluoropropane; and 1,1,1,3,3-pentafluoropropane; and mixtures thereof.

5. The system of claim 4 wherein the halocarbon component is 1,1-dichloro-1-fluoroethane.

6. The system of claim 4 wherein the halocarbon component is a mixture of 3,3-dichloro-1,1,1,2,2-pentafluoropropane; and 1,3-dichloro-1,1,2,2,3-pentafluropropane

7. The system of claim 1 wherein the halocarbon component is a mixture comprised of: a) dichloroethylene; and b) 1,1-dichloro-1-fluoroethane.

8. The system of claim 1 wherein the halocarbon component is a mixture comprised of: a) dichloroethylene; and b) 3,3-dichloro-1,1,1,2,2-pentafluoropropane; 1,3-dichloro-1,1,2,2,3-pentafluropropane, or both.

9. The system of claim 1 wherein the halocarbon component is a mixture comprised of: a) dichloroethylene; and b) at least one halocarbon compound is selected from 1,1,2,2,3-pentafluoropropane; 1,1,2,3,3-pentafluoropropane; 1,1,1,2,3-pentafluoropropane; and 1,1,1,3,3-pentafluoropropane.

10. The system of claim 1 wherein there is a diluent present, which diluent is selected from the group consisting of: vegetable oils; alcohols; ketones and ketoalcohols; ethers; esters; polyhydric alcohol; lower alkyl mono- or di-ethers derived from alkylene glycols; nitrogen containing cyclic compounds; sulfur-containing compounds; and water.

11. The system of claim 10 wherein the diluent is water.

12. A method for knocking-out, but not killing a nest of insects for a finite period of time, which method comprises treating the nest of insects with an effective amount of at least one halocarbon compound selected from one or more of the following formulae:
CₐH_{b}F_{c}Cl_{d}Brₑ i)
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers;
CₐH_{b}F_{c}Cl_{d}BrₑO ii)
wherein:
a is from 2 to 5,
b is from 0 to 11
c is from 0 to 11,
d is from 0 to 3, and
e is from 0 to 2,
with the provision that: i) at least one of F, Cl or Br must be present; ii) that when only F is present there must be at least 5 Fs; and iii) that all ranges are in whole numbers; and
CₐH_{b}F_{c}Cl_{d}Brₑ(OH) iii)
wherein:
a is from 1 to 5,
b is from 0 to 11,
c is from 0 to 11,
d is from 0 to 3, and
e is from 0 to 2,
with the proviso that: i) at least one of F, Cl, or Br must be present; ii) that when only F is present there must be at least 5 Fs; and iii) that all ranges are in whole numbers.

13. The system of claim 12 wherein the halocarbon compound has a boiling point less than about 80° C.

14. The system of claim 12 wherein halocarbon compound has a Kauri Butano Value greater than about 9.

15. The system of claim 12 wherein the halocarbon compound is selected from the group consisting of 1,1-dichloro-1-fluoroethane; 3,3-dichloro-1,1,1,2,-pentafluoropropane; and 1,3-dichloro-1,1,2,2,3-pentafluropropane; 1,1,2,2,3-pentafluoropropane; 1,1,2,3,3-pentafluoropropane; 1,1,1,2,3-pentafluoropropane; and 1,1,1,3,3-pentafluoropropane; and mixtures thereof.

16. The system of claim 15 wherein the halocarbon compound is 1,1-dichloro-1-fluoroethane.

17. The system of claim 15 wherein the halocarbon compound is a mixture of 3,3-dichloro-1,1,1,2,2-pentafluoropropane; and 1,3-dichloro-1,1,2,2,3-pentafluropropane

18. The system of claim 12 wherein the halocarbon compound is a mixture comprised of: a) dichloroethylene; and b) 1,1-dichloro-1-fluoroethane.

19. The system of claim 12 wherein the halocarbon compound is a mixture comprised of: a) dichloroethylene; and b) 3,3-dichloro-1,1,1,2,2-pentafluoropropane; 1,3-dichloro-1,1,2,2,3-pentafluropropane, or both.

20. The system of claim 12 wherein the halocarbon compound is a mixture comprised of: a) dichloroethylene; and b) at least one halocarbon compound is selected from 1,1,2,2,3-pentafluoropropane; 1,1,2,3,3-pentafluoropropane; 1,1,1,2,3-pentafluoropropane; and 1,1,1,3,3-pentafluoropropane.

21. The system of claim 12 wherein there is a diluent present, which diluent is selected from the group consisting of: vegetable oils; alcohols; ketones and ketoalcohols; ethers; esters; polyhydric alcohol; lower alkyl mono- or di-ethers derived from alkylene glycols; nitrogen containing cyclic compounds; sulfur-containing compounds; and water.

22. The system of claim 21 wherein the diluent is water.

23. A method for eradicating nesting insects, which method comprises, applying to the nest of insects a mixture comprised of at least one insecticide and an effective amount of a halocarbon component comprised of at least one or more halocarbon compounds represented by the formulae:
CₐH_{b}F_{c}Cl_{d}Brₑ i)
wherein:
a is from 1 to 5,
b is from 0 to 11,
c is from 0 to 11,
d is from 0 to 3, and
e is from 0 to 2,
with the proviso that: i) there must be at least one F, Cl, or Br present; and ii) that when only F is present there must be at least 5 Fs; and iii) that all ranges are in whole numbers;
CₐH_{b}F_{c}Cl_{d}BrₑO ii)
wherein:
a is from 2 to 5,
b is from 0 to 11
c is from 0 to 11,
d is from 0 to 3, and
e is from 0 to 2,
with the provision that: i) at least one of F, Cl or Br must be present; ii) that when only F is present there must be at least 5 Fs; and iii) that all ranges are in whole numbers; and
CₐH_{b}F_{c}Cl_{d}Brₑ(OH) iii)
wherein:
a is from 1 to 5,
b is from 0 to 11,
c is from 0 to 11,
d is from 0 to 3, and
e is from 0 to 2,
with the proviso that: i) at least one of F, Cl, or Br must be present; ii) that when only F is present there must be at least 5 Fs; and iii) that all ranges are in whole numbers.

24. The system of claim 23 wherein the halocarbon component has a boiling point less than about 80° C.

25. The system of claim 23 wherein halocarbon component has a Kauri Butano Value greater than about 9.

26. The system of claim 23 wherein the halocarbon component is selected from the group consisting of 1,1-dichloro-1-fluoroethane; 3,3-dichloro-1,1,1,2,2-pentafluoropropane; and 1,3-dichloro-1,1,2,2,3-pentafluropropane; 1,1,2,2,3-pentafluoropropane; 1,1,2,3,3-pentafluoropropane; 1,1,1,2,3-pentafluoropropane; and 1,1,1,3,3-pentafluoropropane; and mixtures thereof.

27. The system of claim 26 wherein the halocarbon component is 1,1-dichloro-1-fluoroethane.

28. The system of claim 26 wherein the halocarbon component is a mixture of 3,3-dichloro-1,1,1,2,2-pentafluoropropane; and 1,3-dichloro-1,1,2,2,3-pentafluropropane

29. The system of claim 23 wherein the halocarbon component is a mixture comprised of: a) dichloroethylene; and b) 1,1-dichloro-1-fluoroethane.

30. The system of claim 23 wherein the halocarbon component is a mixture comprised of: a) dichloroethylene; and b) 3,3-dichloro-1,1,1,2,2-pentafluoropropane; 1,3-dichloro-1,1,2,2,3-pentafluropropane, or both.

31. The system of claim 23 wherein the halocarbon component is a mixture comprised of: a) dichloroethylene; and b) at least one halocarbon compound is selected from 1,1,2,2,3-pentafluoropropane; 1,1,2,3,3-pentafluoropropane; 1,1,1,2,3-pentafluoropropane; and 1,1,1,3,3-pentafluoropropane.

32. The system of claim 23 wherein there is a diluent present, which diluent is selected from the group consisting of: vegetable oils; alcohols; ketones and ketoalcohols; ethers; esters; polyhydric alcohol; lower alkyl mono- or di-ethers derived from alkylene glycols; nitrogen containing cyclic compounds; sulfuir-containing compounds; and water.

33. The system of claim 32 wherein the diluent is water.
